(19) United States
(12) Patent Application Publication
(10) Pub. No.: US 2025/0334895 A1
(43) Pub. Date: Oct. 30, 2025

(54) TONER, DEVELOPING AGENT, DEVELOPING AGENT CONTAINER, IMAGE FORMING METHOD, AND IMAGE FORMING APPARATUS

(71) Applicant: Masayuki Ishii, Kanagawa (JP)

(72) Inventor: Masayuki Ishii, Kanagawa (JP)

(73) Assignee: Ricoh Company, Ltd., Tokyo (JP)

(21) Appl. No.: 19/183,194

(22) Filed: Apr. 18, 2025

(30) Foreign Application Priority Data
Apr. 23, 2024 (JP) 2024-069524

(51) Int. Cl. G03G 9/097; G03G 9/087

(52) U.S. Cl. CPC G03G 9/09716; G03G 9/087

(57) ABSTRACT

A toner contains a binder resin, a colorant, and an external additive that contains a titanium oxide fine particle hydrophobized with a silane coupling agent containing n-octyltriethoxy silane, wherein the titanium oxide fine particle contains rutile titanium oxide having a particle diameter of 10 to 35 nm.

### CROSS-REFERENCE TO RELATED APPLICATIONS

This patent application is based on and claims priority pursuant to 35 U.S.C. § 119 to Japanese Patent Application No. 2024-069524, filed on Apr. 23, 2024, in the Japan Patent Office, the entire disclosure of which is hereby incorporated by reference herein.

### BACKGROUND

### Technical Field

The present disclosure relates to a toner, a developing agent, a developing agent container, an image forming method, and an image forming apparatus.

### Description of the Related Art

It is known that fine particles with an average primary particle size of several nanometers to several tens of nanometers have conventionally been used as external additives for toner for a latent electrostatic image (toner for electrophotography). For example, from the perspective of imparting chargeability, fluidity, and hydrophobicity, hydrophobized silica fine particles are used. From the perspective of maintaining chargeability under usage and storage conditions and minimizing variation in the level of retained charge, hydrophobically surface-treated titanium oxide fine particles are commonly used.

Titanium oxide exists in several crystal forms, but the two main types used for electrophotographic applications are anatase titanium oxide and rutile titanium oxide.

Anatase titanium oxide has a roughly spherical shape, making it less likely to cause a decrease in fluidity if externally added to toner. On the other hand, rutile titanium oxide has a flaky to needle-like shape, which can lead to issues such as reduced fluidity if added to toner.

For this reason, highly fluid and lubricative silica or other external additives that perform highly lubricative surface treatments have been used in combination to mitigate these issues to an acceptable level. However, achieving high fluidity through surface treatment for rutile titanium oxide has long been desired.

### SUMMARY

According to embodiments of the present disclosure, a toner is provided which contains a binder resin, a colorant, and an external additive that contains a titanium oxide fine particle hydrophobized with a silane coupling agent containing n-octyltriethoxy silane, wherein the titanium oxide fine particle contains rutile titanium oxide having a particle diameter of 10 to 35 nm.

As another aspect of embodiments of the present disclosure, a developing agent container is provided which contains the developing agent mentioned above.

As another aspect of embodiments of the present disclosure, an image forming method is provided which includes forming a latent electrostatic image on a latent electrostatic image bearer, developing the latent electrostatic image with the developing agent mentioned above to form a visible image, transferring the visible image to the surface of a transfer medium, and fixing the visible image on the surface of the transfer medium.

As another aspect of embodiments of the present disclosure, an image forming apparatus is provided which includes a latent electrostatic image bearer, a latent electrostatic image forming device to form a latent electrostatic image on the latent electrostatic image bearer, a developing device to develop the latent electrostatic image with the developing agent mentioned above to form a visible image, a transfer device to transfer the visible image onto the surface of a transfer medium, and a fixing device to fix the visible image transferred to the surface of the transfer medium.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a schematic diagram of the image forming apparatus according to an embodiment of the present disclosure; and

FIG. 2 is a schematic diagram illustrating an example of the process cartridge according the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a toner is provided which has excellent fluidity and chargeability while minimizing deterioration of the image quality.

### Toner

The toner of the present disclosure contains a mother toner particle containing a binder resin and a colorant, as well as an external additive that coats the mother toner particle. The mother toner particle may furthermore optionally contain other components such as a release agent and a charge control agent.

### External Additive

The external additive contained in the toner of the present disclosure includes titanium oxide fine particles that have been hydrophobized with a silane coupling agent containing n-octyltriethoxysilane and may furthermore optionally include other external additives as necessary. The combined use of other external additives can further enhance, for example, the fluidity, developability, and chargeability of the toner, thereby achieving higher toner performance.

### Titanium Oxide Fine Particle

The titanium oxide fine particles used in the present disclosure are rutile titanium oxide. Rutile titanium oxide has a flaky to needle-like shape. Compared to anatase titanium oxide, which has a roughly spherical shape, its use as an external additive results in inferior toner fluidity. However, it is less likely to be embedded into the toner due to friction and exhibits excellent charge stability.

The particle diameter of the titanium oxide fine particles used in the present disclosure is between 10 nm and 35 nm. A particle size of at least 10 nm reduces aggregation of the titanium oxide fine particles, thereby providing a toner with excellent charge stability. A particle size of at most 35 nm ensures a toner with excellent dispersibility.

Rutile titanium oxide can be procured or manufactured.

One method of producing rutile-type titanium oxide involves reacting ilmenite ore with sulfuric acid to form water-soluble sulfates, removing impurities, and then inducing rutile transformation by adding a rutile transformation promoter during hydrolysis or calcination.

### Silane Coupling Agent

The titanium oxide fine particles used in the present disclosure are hydrophobized with a silane coupling agent. The silane coupling agent in the present disclosure is a compound represented by the formula RₙSiX₄₋ₙ (where n is an integer from 0 to 3, R represents a hydrogen atom or an organic group such as an alkyl group, and X represents a hydrolyzable group such as an alkoxy group).

The silane coupling agent in the present disclosure includes at least n-octyltriethoxysilane and may furthermore optionally contain a short-chain silane coupling agent with a molecular weight of at most 160.

Inclusion of a silane coupling agent containing n-octyltriethoxysilane allows for obtaining a toner with excellent fluidity and chargeability without the use of fluorine-containing silane coupling agents.

### Short-Chain Silane Coupling Agent

It is preferable that the silane coupling agent further include a short-chain silane coupling agent with a molecular weight of at most 160. After the titanium oxide fine particles are hydrophobized with n-octyltriethoxysilane, the untreated hydroxyl groups can be further hydrophobized using a short-chain silane coupling agent, thereby yielding a toner with enhanced hydrophobicity.

There are no particular restrictions on the short-chain silane coupling agent as long as its molecular weight is at most 160, and it may be appropriately selected according to a particular application.

Specific examples include, but are not limited to, dimethyldimethoxysilane (molecular weight: 120), methyltrimethoxysilane (molecular weight: 136), and dimethyldiethoxysilane (molecular weight: 148).

### Other External Additive

The external additive for the toner of the present disclosure may include, in addition to hydrophobically treated titanium oxide fine particles, other external additives.

There are no particular restrictions on the other external additives, and they can be appropriately selected according to a particular application.

Specific examples include, but are not limited to, hydrophobic silica treated with hexamethyldisilazane or silicone oil, strontium titanate, zinc oxide, tin oxide, and other metal oxides, as well as metal salts of fatty acids such as zinc stearate and calcium stearate, and layered double hydroxides such as hydrotalcite. These may be used alone or in a combination of two or more thereof. Among them, hydrophobic silica is preferred from the perspective of improving the fluidity of the toner.

### Binder Resin

There are no particular restrictions on the binder resin contained in the toner of the present disclosure, and it can be appropriately selected according to a particular application. However, it is preferable that the toner contains a crystalline resin.

### Crystalline Resin

Crystalline materials are defined to have atoms and molecules spaciously arranged in a repeated manner and show a diffraction pattern by a general-purpose X-ray diffraction device. Since crystalline resins exhibit thermal melting properties of a rapid change in viscosity near the fixing initiation temperature, they can impart low-temperature fixability to electrophotographic toner.

The crystalline resin is not particularly limited and can be suitably selected to suit to a particular application as long at it has crystallinity. Examples include, but are not limited to, polyester resin (crystalline polyester resin), polyurethane resin, polyurea resin, polyamide resin, polyether resin, vinyl resin, and modified crystalline resin. These may be used alone or in a combination of two or more thereof. Among these, polyester resin (crystalline polyester resin) is particularly preferred.

### Crystalline Polyester Resin

There are no particular restrictions on the crystalline polyester resin, and it can be appropriately selected according to a particular application.

For example, a preferred crystalline polyester resin is synthesized by the reaction of a diol component selected from saturated aliphatic diol compounds having 2 to 12 carbon atoms, particularly 1,4-butanediol, 1,6-hexanediol, 1,8-octanediol, 1,10-decanediol, 1,12-dodecanediol, or their derivatives, with a dicarboxylic acid component selected from dicarboxylic acids having 2 to 12 carbon atoms and containing a double bond (C═C bond), or saturated dicarboxylic acids having 2 to 12 carbon atoms, particularly fumaric acid, 1,4-butanedioic acid, 1,6-hexanedioic acid, 1,8-octanedioic acid, 1,10-decanedioic acid, 1,12-dodecanedioic acid, or their derivatives.

The content of crystalline polyester resin is preferably between 1 part by mass and 30 parts by mass per 100 parts by mass of the mother toner particles. If the proportion is at least 1 part by mass, the low temperature fixing is sufficiently enhanced. A content of at most 30 parts by mass is preferable as it helps minimize the deterioration of image quality, the decrease in the fluidity of the developing agent, and the reduction in image density. Additionally, it allows the toner to maintain sufficient chargeability over a long period and further improves the environmental stability of the toner.

### Other Resins

The binder resin may other resin in addition to the crystalline resin.

The other resin is not particularly limited and can be suitably selected to suit a particular application.

Specific examples include, but are not limited to, styrene polymers and substituted styrene polymers such as polystyrene, poly-p-chlorostyrene, and polyvinyltoluene; styrene copolymers such as styrene-p-chlorostyrene copolymers, styrene-propylene copolymers, styrene-vinyltoluene copolymers, styrene-methyl acrylate copolymers, styrene-ethyl acrylate copolymers, styrene-methacrylate copolymers, styrene-methyl methacrylate copolymers, styrene-ethyl methacrylate copolymers, styrene-butyl methacrylate copolymers, styrene-α-methyl chloromethacrylate copolymers, styrene-acrylonitrile copolymers, styrene-vinyl methyl ether copolymers, styrene-vinyl methyl ketone copolymers, styrene-butadiene copolymers, styrene-isopropylene copolymers, and styrene-maleic acid ester copolymers; and other resins such as polymethyl methacrylate, polybutyl methacrylate, polyvinyl chloride, polyvinyl acetate, polyethylene, polyesters, epoxy resins, polyurethane resins, polyvinyl butyral resins, polyacrylic resins, rosin, modified rosins, terpene resins, phenol resins, aliphatic or aromatic hydrocarbon resins, and aromatic petroleum resins. These may be used alone or in a combination of two or more thereof.

### Colorant

There is no specific limit to the coloring agent used as the toner material forming the mother toner particle. Any known dye or pigment can be selected to a particular purpose. Specific examples of the coloring agents for use in the toner of the present disclosure include, but are not limited to, known dyes and pigments such as carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone. These materials can be used alone or in combination.

The proportion of the colorant in the mother toner particle is preferably from 1 to 15 percent by mass and more preferably from 3 to 10 percent by mass.

The colorant and the resin can be used in combination as a master batch. There is no specific limit to the resins for use in the master batch and any known resin can be selected to a particular purpose.

Specific examples thereof include, but are not limited to, monopolymers of styrene or substituted styrene, styrene-based copolymers, polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, polyacrylic resins, rosin, modified rosins, terpene resins, aliphatic hydrocarbon resins, alicyclic hydrocarbon resins, aromatic petroleum resins, chlorinated paraffin, and paraffin. These can be used alone or in combination.

### Release Agent

There is no specific limit to the release agents and any known release agent can be selected to a particular purpose. Waxes can be used as the release agent.

Specific examples of such waxes include, but are not limited to, wax having a carbonyl group, polyolefin wax, and long-chain hydrocarbons. These can be used alone or in combination. In particular, wax having a carbonyl group is preferable.

Specific examples of the waxes having a carbonyl group include, but are not limited to, polyalkane acid esters, polyalkanol esters, polyalkane acid amides, polyalkyl amides, and dialkyl ketones. In particular, polyalkane acid esters are preferable.

Specific examples of the polyalkane acid esters include, but are not limited to, carnauba wax, montan wax, trimethylol propane tribehenate, pentaerythritol tetrabehenate, pentaerythritol diacetate dibehenate, glycerin tribehenate, and 1,18-octadecanediol distearate.

Specific examples of the polyalkanol esters include, but are not limited to, trimellitic acid tristearyl and distearyl maleate.

One specific example of the polyalkane acid amide is dibehenyl amide. One specific example of the polyalkyl amide is trimellitic acid tristearyl amide.

One specific example of the dialkyl ketone is distearyl ketone.

Specific examples of the polyolefine waxes include, but are not limited to, polyethylene waxes and polypropylene waxes.

Specific examples of the long-chain hydrocarbons include, but are not limited to, paraffin wax and sazol wax.

There is no specific limit to the melting point of the release agent. The melting point can be set to a particular purpose and is preferably from 45 degrees Celsius to 120 degrees Celsius. If the melting point is lower than 45 degrees Celsius, the release agent tends to have an adverse impact on high temperature stability. If the melting point surpasses 120 degrees Celsius, cold offset tends to occur during fixing at low temperatures.

The release agent preferably has a melt viscosity of from 5 cps to 1,000 cps and more preferably from 10 cps to 100 cps at a temperature 20 degrees Celsius higher than the melting point of the release agent. If the melt viscosity is less than 5 cps, the releasing property tends to deteriorate. If the melt viscosity surpasses 1,000 cps, the hot offset resistance and the low temperature fixability of the toner are not easily improved.

The proportion of the release agent in the mother toner particle is not particularly limited and can be suitably selected to suit to a particular application. It is preferably from 1 to 40 percent by mass and more preferably from 3 to 30 percent by mass. A proportion exceeding 40 percent by mass may degrade flowability of the toner.

### Charge Control Agent

Charge control agents and other agents are optionally used as toner materials forming the mother toner particle.

There is no specific limit to the charge control agent and positive or negative charge control agents can be selected to a particular application depending on the plus and minus of charges applied to an image bearer.

For example, resins or compounds having electron donating functional groups, azo dyes, or metal complexes of organic acids can be used as the negative charge control agent. Specific examples of such negative charge control agents include, but are not limited to, Bontron (product number: S-31, S-32, S-34, S-36, S-37, S-39, S-40, 5-44, E-81, E-82, E-84, E-86, E-88, A, 1-A, 2-A, and 3-A, all available from Orient Chemical Industries Co., Ltd.); KayaCharge (Product number: N-1 and N-2) and KayaSetBlack (product number: T-2 and 004, all manufactured by Nippon Kayaku Co., Ltd.), Aizen Spiron Black (T-37, T-77, T-95, TRH, TNS-2, all manufactured by Hodogaya Chemical Co., Ltd.); and FCA-1001-N, FCA-1001-NB, FCA-1001-NZ, all manufactured by Fujikura Kasei Co., Ltd.). These can be used alone or in combination.

Examples of the positive charge control agents include, but are not limited to, basic compounds such as modified agents such as nigrosine dyes, cationic compounds such as quaternary ammonium salt, and metal salts of higher aliphatic acids. Specific examples include, but are not limited to, Bontron (product number: N-01, N-02, N-03, N-04, N-05, N-07, N-09, N-10, N-11, N-13, P-51, P-52, and AFP-B, all manufactured by Orient Chemical Industries Co., Ltd.); TP-302, TP-415, and TP-4040, all manufactured by Hodogaya Chemical Co., Ltd.); Copy Blue PR and Copy Charge (product number: PX-VP-435 and NX-VP-434, all manufactured by Hoechst Japan Co., Ltd.); FCA-(product number: 201, 201-B-1, 201-B-2, 201-B-3, 201-PB, 201-PZ, 301, all manufactured by Fujikura Kasei Co., Ltd.); and PZ (product number: 1001, 2001, 6001, and 7001, all manufactured by Shikoku Chemical Corporation). These can be used alone or in combination.

The content of the charge control agent is determined depending on the type of the binder resin and the method of manufacturing the mother toner particle and therefore is not unambiguously defined. However, the content of the charge control agent is preferably from 0.05 percent by mass to 1.0 percent by mass based on the entire of the binder resin. If the additional amount surpasses 1.0 percent by mass, the toner tends to have an excessively large amount of charge, which reduces the effect of the charge control agent. Therefore, the electrostatic attraction force between a developing roller and the toner increases, resulting in deterioration of the fluidity of the toner and a decrease in the image density. If the content is less than 0.05 percent by mass, the charge initial rising property and the charging size of toner tend to be not sufficient, which easily has an impact on output toner images.

### Method of Manufacturing Toner

The toner can be manufactured by a method (pulverization method) known in the art including melt-kneading toner materials, pulverizing the melt-kneaded matter obtained, classifying the pulverized matter obtained to obtain mother toner particles, and externally-adding an external additive to the mother toner particle obtained.

In the melt-kneading, the toner materials are mixed and the mixture obtained is charged in a melt-kneading machine for melt-kneading. The melt-kneading machine includes, but is not limited to, a single or twin screw continuous melt-kneader and a batch-melt-kneader using a roll mill.

Specific examples include, but are not limited to, a KTK type twin screw extruder manufactured by Kobe Steel, Ltd., a TEM type extruder manufactured by Toshiba Machine Co., Ltd., a twin screw extruder manufactured by KCK Engineering, a PCM-type twin screw extruder, manufactured by Ikegai Corp., and a kokneader manufactured by Buss Ag.

Preferably, this melt-kneading is conducted under suitable conditions to avoid severing the molecular chain of a binder resin.

Specifically, the temperature in the melt-kneading is determined according to the softening point of the binder resin. If the temperature is too high relative to the softening point, the molecular chain is likely to be severely severed. When the temperature is too low relative to the softening point, dispersion may not proceed smoothly.

In the pulverizing process, the melt-kneaded matter obtained in the melt-kneading is pulverized. In this pulverizing, the melt-kneaded matter is preferably subjected to coarse pulverizing, followed by fine pulverizing. The melt-kneaded matter is pulverized by colliding with a collision board in a jet stream, colliding particles in a jet stream, or pulverizing at narrow gaps between a stator and a rotor that mechanically rotates.

In the classifying process, the pulverized matter obtained in the pulverizing is classified and adjusted to have a predetermined particle diameter. The pulverized matter can be classified by removing fine particles with a device such as a cyclone, a decanter, or a centrifugal. After the pulverizing, the pulverized matter is classified in an air stream by centrifugal to manufacture mother toner particles with a predetermined particle diameter.

In the externally adding, an external additive is externally added to the mother toner particles obtained in the classifying. The mother toner particle and external additive are mixed and stirred in a mixer. During this process, the external additive is broken down, and the resulting fragments coat the surface of the mother toner particle.

External additives can adhere to mother toner particles by applying a mechanical impact caused by mixing and stirring.

Specific methods of applying a mechanical impact include, but are not limited to, using a high-speed rotating blade to impact particles and employing jet air to accelerate and collide particles against each other or directing agglomerated particles towards a collision board for impact.

Specific examples of such mixing devices that apply a mechanical impact include, but are not limited to, ONG MILL (available from Hosokawa Micron Co., Ltd.), modified I TYPE MILL (available from Nippon Pneumatic Mfg. Co., Ltd.) in which the pressure of pulverization air is reduced, HYBRIDIZATION SYSTEM (manufactured by Nara Machine Co., Ltd.), KRYPTRON SYSTEM (available from Kawasaki Heavy Industries, Ltd.), and automatic mortars.

In the case of obtaining mother toner particles by emulsifying or dispersing a toner material liquid (oil phase) in an aqueous medium (water phase) (wet process), the process involves preparing a toner material liquid (oil phase) by dissolving or dispersing a toner material—containing a binder resin and/or a binder resin precursor, a colorant, and, optionally, a release agent—in an organic solvent, emulsifying or dispersing the oil phase in an aqueous medium (water phase), and then obtaining mother toner particles through a solvent removal process. Subsequently, an external additive treatment can be performed in the same manner as in the aforementioned pulverization method.

It is preferable that the volume average particle diameter (Dv) of the mother toner particle obtained by either a pulverization method or a wet method be from 3.0 μm to less than 6.0 μm and the ratio (Dv/Dn) of the volume average particle diameter (Dv) to the number average particle diameter (Dn) of the mother toner particle be from 1.05 to 1.25.

If the volume average particle diameter (Dv) is smaller than 3.0 μm, the toner in a two component developing agent (composed of toner and carrier) tends to adhere to the surface of the carrier when the two component developing agent is stirred in a development device for a long period of time. This adhesion easily results in depriving the carrier of the charging power. If the mother toner particle is used in a single component developing agent, filming of the toner on a development roller and cohesion of the toner on members such as a blade for regulating the thickness of the toner layer tend to occur.

By contrast, if the toner particle diameter is greater than 6.0 μm, quality images with high definitions is not easily produced. In addition, if the toner in a developing agent is replenished, variation of the particle diameter of the toner tends to increase. This mechanism applies to a case in which the ratio (Dv/Dn) of the volume average particle diameter (Dv) to the number average particle diameter (Dn) is greater than 1.25. In addition, a case in which the ratio (Dv/Dn) is less than 1.05 is preferable in terms of the stabilization of toner behavior and the uniformity of charging size but unable to charge the toner sufficiently and degrades the cleanability in some cases.

### Developing Agent

The developing agent of the present disclosure is a single-component developing agent simply formed of the toner of the present disclosure or a two component developing agent formed of carrier and the toner of the present disclosure. For a high performance printers, etc. that keep with the improvement of the processing speed, using a two component developing agent is preferable in terms of the length of the working life and other properties.

The ratio of mixing the toner with the carrier in the two component developing agent is preferably from 1 to 10 parts by mass based on 100 parts by mass of the carrier.

If the toner of the present disclosure is used as a one-component developing agent, its particle size variation remains minimal even when consumed and replenished. This helps prevent toner filming on the developing roller and fusion bonding to components such as the blade that regulates the toner layer thickness. As a result, good and stable developability is maintained even when the developing agent is used (stirred) for an extended period, ensuring the production of high-quality images.

In a case of a two-component developing agent using the toner of the present disclosure, even when the toner is consumed and replenished for an extended period of time, the particle diameter of the toner in the developing agent varies little. In addition, good and stable developability is sustained even when the developing agent is stirred in a development device for an extended period of time.

### Carrier

There is no specific limitation to the carrier and it can be suitably selected to suit to a particular application. The carrier preferably contains a core material and a resin layer covering the core material.

### Core Material

There is no specific limitation to the core material and it can be suitably selected among known materials. For example, manganese-strontium (Mn—Sr) based material and manganese-magnesium (Mn—Mg) based material having 50 to 90 emu/g are preferable. To ensure the image density, highly magnetized materials such as powdered iron having at least 100 emu/g and magnetite having 75 to 120 emu/g are preferable. In addition, weakly magnetized copper-zinc (Cu—Zn) based materials with magnetization values ranging from 30 emu/g to 80 emu/g are preferable, as they help reduce the impact of contact between toner filaments formed on the developing roller and the photoconductor. This contributes to improved image quality. These can be used alone or in combination.

The core material preferably has a weight average particle diameter of from 10 μm to 200 μm and more preferably from 40 μm to 100 μm. If the weight average particle diameter is less than 10 μm, fine powder component of carrier tends to increase and the magnetization per particle tends to decrease, which leads to scattering of the carrier particles. If the weight average particle diameter is greater than 150 μm, the specific surface area tends to decrease, resulting in scattering of toner. In a full color image in which solid portions account for a large part, reproducibility tends to deteriorate particularly in the solid portions.

### Resin Layer

There is no specific limit to the materials for the resin layer and any known resin can be suitably selected to a particular application.

Specific examples thereof include, but are not limited to, amino-based resins, polyvinyl-based resins, polystyrene-based resins, polycarbonate-based resins, polyethylene resins, polyvinyl fluoride resins, polyvinylidene fluoride resins, polytrifluoroethylene resins, polyhexafluoropropylene resins, copolymers of vinylidenefluoride and acrylate monomer, copolymers of vinylidenefluoride and vinylfluoride, fluoroterpolymers such as terpolymers of tetrafluoroethylene, fluorovinylidene, and monomer including no fluorine atom, and silicone resins. These can be used alone or in combination.

Specific examples of the amino-based resins include, but are not limited to, urea-formaldehyde resins, melamine resins, benzoguanamine resins, urea resins, polyamide resins, and epoxy resins.

Specific examples of the polyvinyl-based resins include, but are not limited to, acrylic resins, polymethyl methacrylate resins, polyacrylonitrile resins, polyvinyl acetate resins, polyvinyl alcohol resins, and polyvinyl butyral resins.

Specific examples of the polystyrene resins include, but are not limited to, polystyrene resins and styrene-acrylic copolymers. One specific example of the halogenated olefin resins is polyvinly chloride.

Specific examples of the polyester resins include, but are not limited to, polyethyleneterephthalate resins and polybutyleneterephthalate resins.

Optionally, electroconductive powder can be added to the resin layer. Specific examples of such electroconductive powder include, but are not limited to, metal powder, carbon blacks, titanium oxide, tin oxide, and zinc oxide. The electroconductive powder preferably has an average particle diameter of at most 1 μm. If the average particle diameter surpasses 1 μm, controlling electric resistance may become difficult.

The resin layer described above can be formed by, for example, dissolving the silicone resin described above in a solvent to prepare a liquid application and applying the liquid to the surface of the core described above by a known application method followed by drying and baking.

Specific examples of the application methods include, but are not limited to, a dip coating method, a spray coating method, and a brushing method.

There is no specific limit to the solvent and the solvent can be selected to a particular application.

Specific examples thereof include, but are not limited to, toluene, xylene, methylethyl ketone, methylisobutyll ketone, and methyl cellosolve, and butylacetate.

There is no specific limitation to the baking. An external heating system or an internal heating system can be used. For example, a method of using an electric furnace such as a fixed electric furnace, a fluid electric furnace, and a rotary electric furnace, and a burner furnace, and a method of using a microwave can be suitably used.

The proportion of the resin layer in the carrier is preferably from 0.01 to 5.0 percent by mass. A content that is less than 0.01 percent by mass tends to make it difficult to form a uniform layer on the surface of the core material. A content that is greater than 5.0 percent by mass tends to result in an excessively thick layer, thereby causing granulation between carrier particles.

As described above, the developing agent of the present disclosure is well-suited for image formation using known electrophotographic methods, including magnetic single-component development, non-magnetic single-component development, and two-component development.

Since it contains the toner of the present disclosure, the developing agent enables the formation of high-quality images with excellent cleanability, image sharpness, and durability in electrophotographic imaging.

### Developing Agent Container

The developing agent container in the present disclosure contains a developing agent.

Embodiments of the developing agent container include a container with a developing agent, a developing unit (developing device), and a process cartridge.

The container with a developing agent means a container containing a developing agent.

The developing unit includes device that accommodates a developing agent and develops with it.

The process cartridge includes at least a latent electrostatic image bearer integrated with a developing device, and is detachably attachable to an image forming apparatus.

The developing device includes at least a developing agent container that contains a developing agent and a developing agent bearer that bears and conveys the developing agent in the developing agent container. The developing device may furthermore optionally include a regulating member for regulating the thickness of the developing agent borne on the bearer.

### Image Forming Method and Image Forming Apparatus

The image forming method of the present disclosure includes forming a latent electrostatic image on a latent electrostatic image bearer, developing the latent electrostatic image with the developing agent of the present disclosure to obtain a visible image, transferring the visible image to the surface of a transfer medium, and fixing the visible image transferred onto the surface of the transfer medium. The image forming method furthermore optionally includes other processes.

The other processes include a charge removal process in which a charge removal bias is applied to the electrostatic latent image carrier to remove charge, a cleaning process in which residual toner on the electrostatic latent image carrier is removed, a recycling process in which the toner removed in the cleaning process is recycled to the developing unit, and a control process for controlling these processes.

The image forming apparatus of the present disclosure includes a latent electrostatic image bearer, a latent electrostatic image forming device to form a latent electrostatic image on the latent electrostatic image bearer, a developing device to develop the latent electrostatic image with the developing agent of the present disclosure to form a visible image, a transfer device to transfer the visible image onto the surface of a transfer medium, and a fixing device to fix the visible image transferred onto the surface of the transfer medium. The image forming apparatus may furthermore optionally include other members.

The other members include a discharging device that applies a discharging (quenching) bias to the latent electrostatic image bearer to remove charge, a cleaning device that removes residual toner from the latent electrostatic image bearer, a recycling device that recycles the toner removed in the cleaning process to the developing device, and a control device that controls these processes.

### Latent Electrostatic Image Forming Process and Latent Electrostatic Image Forming Device

In the latent electrostatic image forming, latent electrostatic images are formed on a latent electrostatic image bearer. The latent electrostatic image forming process is suitably carried out by the latent electrostatic image forming device included in the image forming apparatus of the present disclosure.

The latent electrostatic image forming device includes, for example, at least a charging device as a charger to uniformly charge the surface of the latent electrostatic image bearer and an irradiating device as an irradiator to irradiate the surface of the latent electrostatic image bearer with light according to the obtained image information.

Latent Electrostatic Image Bearer There is no specific limit to the latent electrostatic image bearer, the material, the form, the structure, and the size of the image bearer and any known image bearer can be suitably selected to a particular application. A drum-like form is preferable.

Specific examples include, but are not limited to, inorganic photoconductors of materials such as amorphous silicon and selenium and organic photoconductors (OPC) of materials such as polysilane and phthalopolymethine.

One example of the organic photoconductor is a layered photoconductor, including layers—a charge-generation layer formed of a non-metallic material like phthalocyanine, or gallium phthalocyanine or titanyl phthalocyanine dispersed in a binder resin and a charge-transport layer formed of a charge transport material dispersed in a binder resin—stacked on a substrate such as an aluminum drum.

Another type is a single-layer photoconductor with a single-layer structure on a substrate, featuring a photosensitive layer formed of both charge-generation and a charge-transport material dispersed in a binder resin. In the single-layer photoconductor, hole transport agents and electron transport agents can be added to the photosensitive layer as charge transport materials. Additionally, an undercoat layer may be provided between the substrate and the charge generation layer of a multi-layer photoconductor or the substrate and the photosensitive layer of a single-layer photoconductor.

### Charging Device

The charging device (charger) is not particularly limited and can be suitably selected to suit to a particular application.

Specific examples include, but are not limited to, a known contact type charger that includes an electroconductive or semiconductive roller, brush, film, or a rubber blade, and a non-contact type charger using corona discharging such as corotron and scorotron. Preferably, the charger is disposed in contact or non-contact with the latent electrostatic image bearer and applies a direct voltage and an alternating voltage superimposed thereon to the surface of the image bearer. The charger is preferably a charging roller disposed in contact with the latent electrostatic image bearer with a gap tape therebetween. It is also preferable that the charging roller apply a direct voltage on which an alternate voltage is superimposed to charge the surface of the latent electrostatic image bearer. The charger may be provided to a process cartridge that accommodates the developing agent of the present disclosure.

### Latent Electrostatic Image Forming Device

There is no particular limitation to the latent electrostatic image forming device (irradiator) and it can be suitably selected to suit to a particular application as long as the irradiator can irradiate the surface of a latent electrostatic image bearer charged with the charger according to image information. Specific examples include, but are not limited to, a photocopying optical system, a rod lens array system, a laser optical system, and a liquid crystal shutter optical system.

The dorsal irradiation system, in which a latent electrostatic image bearer is irradiated from its rear side can be also employed. The latent electrostatic image forming device may be provided to a process cartridge that accommodates the developing agent of the present disclosure.

### Developing Process and Developing Device

In the developing process, the latent electrostatic image formed in the latent electrostatic latent image forming process is developed with the developing agent of the present disclosure to form a visible image. The developing process is suitably carried out with the developing device includes in the image forming apparatus of the present disclosure.

Any known developing device that can conduct development with the toner or the developing agent of the present disclosure is usable and suitably selected to a particular application. For example, a development device is suitable that accommodates the toner or the developing agent of the present disclosure and includes at least a developing agent bearer which provides the toner or the developing agent to a latent electrostatic image in a contact or non-contact manner. Preferably the developing device includes a developing agent container (container containing the developing agent) detachably attachable to the development device.

The developing device is either of a dry development type or a wet development type and in addition can be of a single color development type or a multi-color development type. One example of the developing devices includes a stirrer that stirs and triboelectrically charges the developing agent and a rotary magnet roller. In the developing unit, for example, the toner and the carrier are mixed and agitated to charge the toner due to the friction therebetween. The toner is held on the surface of the rotating magnet roller, forming a magnet brush like a filament. Since the magnet roller is provided near the latent electrostatic image bearer, some toner forming the magnet brush on the magnet roller's surface is electrically attracted to the surface of the latent electrostatic image bearer. As a result, the latent electrostatic image is developed with the toner and rendered visible with the toner on the surface of the latent electrostatic image bearer. It is preferable to apply an alternating electric field to move the toner to the surface of the latent electrostatic image bearer.

As a development method, a premix development system, in which a premixed developing agent containing toner and carrier mixed in advance is supplied, may be adopted. In the premix developing method, the developing agent in the developing device can be gradually refreshed by ejecting the excess developing agent corresponding to the increased amount of carrier within the developing device. As a result, this approach extends the developing agent's replacement cycle by mitigating its degradation, thereby reducing the effort required for replacement.

### Transfer Process and Transfer Device

In the transfer process, the visible image formed in the developing process is transferred onto the surface of a transfer medium. The transfer process can be suitably performed by the transfer device included in the image forming apparatus of the present disclosure.

In the transferring process, it is preferable to use an intermediate transfer body. The visible image is primarily transferred to an intermediate transfer body and then secondarily transferred to a transfer medium. Furthermore, it is also preferable to employ a system including a primary transfer process of transferring a visible image developed with two or more color toner, preferably, full color toner, to an intermediate transfer body to form a complex transferred image and a secondary transfer process of transferring the complex transferred image to a transfer body. The visible image can be transferred by, for example, a transfer charger to charge the latent electrostatic image bearer.

The transfer device preferably includes a primary transfer device for transferring visible images to an intermediate transfer body to form a complex transfer image and a secondary transfer device for transferring the complex transfer image to a transfer medium. The transfer device (the primary transfer device and the secondary transfer device) preferably includes at least a transfer unit that peel-off charges the visible image formed on the latent electrostatic image bearer toward the transfer medium. One or more transfer devices can be provided. Specific examples of the transfer units include, but are not limited to, a corona transfer unit employing corona discharging, a transfer belt, a transfer roller, a pressure transfer roller, and an adhesive transfer unit.

### Fixing Process and Fixing Device

In the fixing process, the visible image transferred onto the surface of the transfer medium in the transfer process is fixed. The fixing process can be suitably performed by the fixing device included in the image forming apparatus of the present disclosure.

In the fixing process, each color toner may be fixed individually after being transferred onto the transfer medium, or all color toners may be fixed simultaneously in a stacked state.

As the fixing device, there is no specific limitation to it and it can be suitably selected to suit to a particular application. It is preferable to carry out fixing with heat and pressure using the fixing device. The fixing device preferably has a roller-like form or a belt like form. For example, it is suitable to use a combination of a heating roller and a pressure roller or a combination of a heating roller, a pressure roller, and an endless belt. The heating temperature is preferably from 80 to 200 degrees Celsius.

In the present disclosure, it is suitable to use a fixing device including a heating substance that has a heating substance, a film that contacts the heating substance, and a pressure member that is pressed against the heating substance via the film and conducting heat and pressure fixing while the transfer element (transfer medium) on which an un-fixed image is formed passes between the film and the pressure member.

Depending on particular applications, for example, a known optical fixing device can be used together with or instead of the fixing device.

### Discharging (Quenching) Process and Discharging (Quenching) Device

The discharging device discharges the latent electrostatic image bearer by applying a discharging bias thereto. The discharging process can be suitably performed by the discharging device optionally included in the image forming apparatus of the present disclosure.

Any known discharging device that can apply a discharging bias to a latent electrostatic image bearer is suitably selected and used. For example, a discharging lamp is suitably used.

### Cleaning Process and Cleaning Device

In the cleaning process, the toner remaining on the surface of the latent electrostatic image bearer is removed. The cleaning process can be suitably performed by the cleaning device optionally included in the image forming apparatus of the present disclosure.

As the cleaner, any known cleaner that can remove the toner remaining on the surface of the latent electrostatic image bearer is suitable. For example, a magnetic brush cleaner, an electrostatic brush cleaner, a magnetic roller cleaner, a blade cleaner, a brush cleaner, and a web cleaner are usable. The cleaning device may be provided to a process cartridge that accommodates the developing agent of the present disclosure.

### Recycling Process and Recycling Device

In the recycling process, the toner removed in the cleaning process is recycled to the developing device. The recycling process can be suitably performed by the recycling device optionally included in the image forming apparatus of the present disclosure.

There is no specific limit to the recycling device. For example, any known transfer device is suitable.

### Control Process and Control Device

The control process controls each of the processes mentioned above. The control process can be suitably performed by the control device (controller) optionally included in the image forming apparatus of the present disclosure.

There is no specific limit to the controller as long as the controller controls the behavior of each device. For example, devices such as a sequencer and a computer are usable.

Embodiments of the present disclosure are described with reference to the accompanying drawings.

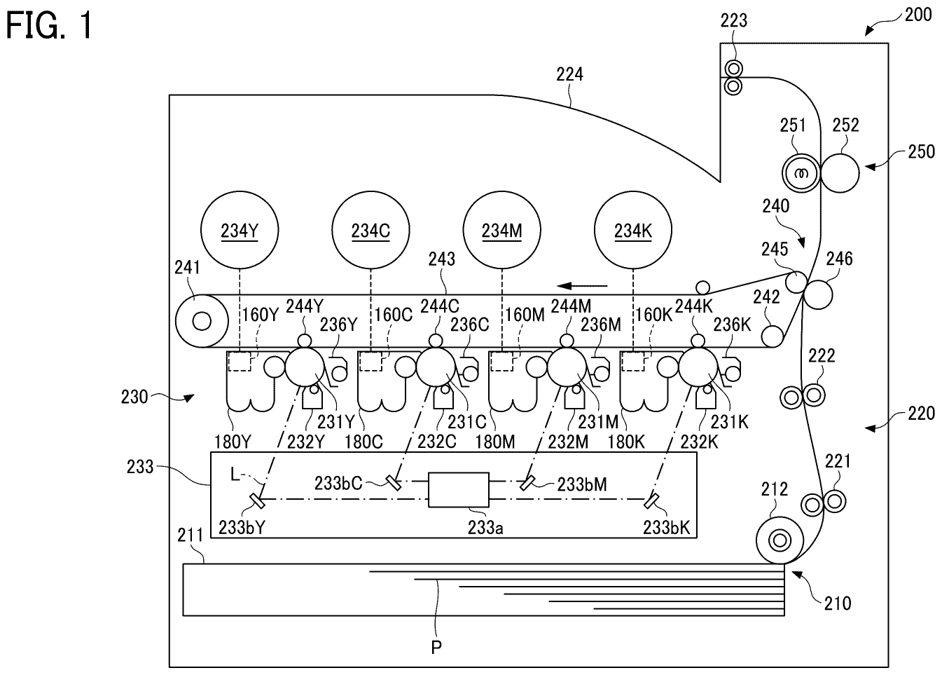

FIG. 1 is a diagram illustrating a schematic diagram of the image forming apparatus according to an embodiment of the present disclosure.

One of the image forming apparatuses in the present embodiment is a printer. However, the image forming apparatus is not particularly limited to an apparatus such as a printer, a photocopier, a facsimile machine, or a multifunction peripheral as long as it can form images with toner.

An image forming apparatus 200 includes a sheet feeding unit 210, a conveyance unit 220, an image forming device (latent electrostatic image forming device) 230, a transfer device (transfer unit) 240, and a fixing device (fixing unit) 250.

The sheet feeding unit 210 includes a sheet feeding cassette 211 on which sheets to be fed are piled and a feeding roller 212 that feeds a sheet (recording medium) P piled on the sheet feeding cassette 211 one by one.

The conveyance unit 220 includes a roller 221 for conveying the sheet P fed by the feeding roller 212 toward the transfer device 240, a pair of timing rollers 222 for pinching the front end of the sheet P conveyed by the roller 221 on standby and sending out the sheet P to the transfer device 240 at a particular timing, and ejection rollers 223 for ejecting the sheet P on which a color toner image is fixed by the fixing device 250 to an ejection tray 224.

The image forming device 230 includes an image forming unit (latent electrostatic image bearer) 180Y that forms an image using a developing agent containing yellow toner, an image forming unit 180C that forms an image using a developing agent containing cyan toner, an image forming unit 180M that forms an image using a developing agent containing magenta toner, and an image forming unit 180K that forms an image using a developing agent containing black toner, sequentially standing from left to right in the drawing with a particular interval, a charging device (charger) 232, and an irradiator 233. The irradiator 233 has a light source 233a and a polygon mirror 233b.

Any of the image forming units (180Y, 180C, 180M, 180K) can be referred to as an image forming unit when it indicates an arbitrary unit.

In addition, the developing agent contains toner and carrier. The four image forming units (180Y, 180C, 180M, 180K) have substantially the same structure except for the individual developing agents used for respective image forming units.

The transfer device 240 includes a driving roller 241, a driven roller 242, an intermediate transfer belt 243 disposed rotatable counterclockwise in the drawing in accordance with the drive of the driving roller 241, a primary transfer roller (244Y, 244C, 244M, and 244K) disposed facing latent electrostatic image bearers (231Y, 231M, 231C, 231K) with the intermediate transfer belt 243 therebetween, and a secondary facing roller 245 and a secondary transfer roller 246 disposed facing each other at the point of the toner image transferred to the sheet P with the intermediate transfer belt 243 therebetween. It is provided with a cleaning device 236 that removes residual transfer toner remaining on the surface of the latent electrostatic image bearers (231Y, 231M, 231C, 231K).

The intermediate transfer belt 243 may also include an elastic intermediate transfer belt. The elastic intermediate transfer belt can have a structure in which a flexible elastic layer is laminated on a relatively rigid base layer with sufficient bendability.

Additionally, to prevent the intermediate transfer belt 243 from meandering, a guide member may be provided on its inner peripheral surface.

A fixing device 250 with a heater inside includes a fixing belt 251 for heating the sheet P and a pressing roller 252 for forming a nip with the fixing belt 251 by rotatably pressing it. Heat is applied with pressure to the color toner image on the sheet P at the nipping portion, thereby fixing the color toner image. The sheet P on which the color toner image is fixed is ejected to the ejection tray 224 by the ejection rollers 223, which completes a series of image forming process.

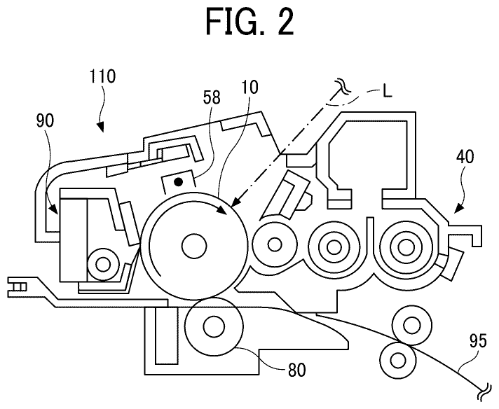

FIG. 2 is a diagram illustrating an example of a process cartridge of the present disclosure.

The process cartridge 110 includes a drum photoconductor (latent electrostatic image bearer) 10, a corona charger 58, a developing device 40, a transfer roller 80, and a cleaning device (cleaner) 90.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto.

### Preparation of Titanium Oxide Fine Particles A

One hundred parts by mass of untreated rutile titanium oxide with an average primary particle diameter of 15 nm was dispersed in a toluene solvent, followed by the addition of 15 parts by mass of n-octyltriethoxysilane. The mixture was then subjected to dispersion treatment to prevent the titanium oxide particles from aggregating and fusing together, dried, and pulverized to obtain titanium oxide fine particles A.

Preparation of Titanium Oxide Fine Particles B One hundred parts by mass of untreated rutile titanium oxide with an average primary particle diameter of 15 nm was dispersed in a toluene solvent, followed by the addition of 10 parts by mass of n-octyltriethoxysilane. The mixture was then subjected to dispersion treatment to prevent the titanium oxide particles from aggregating and fusing together. Next, 6 parts by mass of dimethyldimethoxysilane were added, and after the dispersion treatment was performed, drying and pulverization were carried out to obtain titanium oxide fine particles B.

### Preparation of Titanium Oxide Fine Particles C

One hundred parts by mass of untreated rutile titanium oxide with an average primary particle diameter of 35 nm was dispersed in a toluene solvent, followed by the addition of 8 parts by mass of n-octyltriethoxysilane. The mixture was then subjected to dispersion treatment to prevent the titanium oxide particles from aggregating and fusing together. Next, 8 parts by mass of dimethyldimethoxysilane were added, and after the dispersion treatment was performed, drying and pulverization were carried out to obtain titanium oxide fine particles C.

### Preparation of Titanium Oxide Fine Particles D

One hundred parts by mass of untreated rutile titanium oxide with an average primary particle diameter of 35 nm was dispersed in a toluene solvent, followed by the addition of 8 parts by mass of n-octyltriethoxysilane. The mixture was then subjected to dispersion treatment to prevent the titanium oxide particles from aggregating and fusing together, dried, and pulverized to obtain titanium oxide fine particles D.

### Preparation of Titanium Oxide Fine Particles E

One hundred parts by mass of untreated rutile titanium oxide with an average primary particle diameter of 15 nm was dispersed in a toluene solvent, followed by the addition of 12 parts by mass of dimethylmethoxysilane. The mixture was then subjected to dispersion treatment to prevent the titanium oxide particles from aggregating and fusing together. Next, 8 parts by mass of dimethyldiethoxysilane were added, and after the dispersion treatment was performed, drying and pulverization were carried out to obtain titanium oxide fine particles E.

### Preparation of Titanium Oxide Fine Particles F

One hundred parts by mass of untreated rutile titanium oxide with an average primary particle diameter of 15 nm was dispersed in a toluene solvent, followed by the addition of 20 parts by mass of silicone oil with an average molecular weight of approximately 1,500. The mixture was then subjected to dispersion treatment to prevent the titanium oxide particles from aggregating and fusing together, dried, and pulverized to obtain titanium oxide fine particles F.

### Preparation of Titanium Oxide Fine Particles G

One hundred parts by mass of untreated rutile titanium oxide with an average primary particle diameter of 55 nm was dispersed in a toluene solvent, followed by the addition of 8 parts by mass of n-octyltriethoxysilane. The mixture was then subjected to dispersion treatment to prevent the titanium oxide particles from aggregating and fusing together, dried, and pulverized to obtain titanium oxide fine particles G.

### Preparation of Titanium Oxide Fine Particles H

One hundred parts by mass of untreated anataze titanium oxide with an average primary particle diameter of 15 nm was dispersed in a toluene solvent, followed by the addition of 20 parts by mass of silicone oil with an average molecular weight of approximately 1,500. The mixture was then subjected to dispersion treatment to prevent the titanium oxide particles from aggregating and fusing together, dried, and pulverized to obtain titanium oxide fine particles H.

### Preparation of Titanium Oxide Fine Particles I

One hundred parts by mass of untreated rutile titanium oxide with an average primary particle diameter of 35 nm was dispersed in a toluene solvent, followed by the addition of 8 parts by mass of hexamethyl disilazane. The mixture was then subjected to dispersion treatment to prevent the titanium oxide particles from aggregating and fusing together, dried, and pulverized to obtain titanium oxide fine particles I.

The preparation conditions of titanium oxide fine particles A to I are shown in Table 1.

TABLE 1

Titanium oxide

| | | Particle | Content |
|---|---|---|---|
| | Crystal | diameter | (parts by |
| | structure | (nm) | mass) |
| Titanium | Rutile type | 15 | 100 |
| oxide | | | |
| Fine | | | |
| particle A | | | |
| Titanium | Rutile type | 15 | 100 |
| oxide | | | |
| Fine | | | |
| particle B | | | |
| Titanium | Rutile type | 35 | 100 |
| oxide | | | |
| Fine | | | |
| particle C | | | |
| Titanium | Rutile type | 35 | 100 |
| oxide | | | |
| Fine | | | |
| particle D | | | |
| Titanium | Rutile type | 15 | 100 |
| oxide | | | |
| Fine | | | |
| particle E | | | |
| Titanium | Rutile type | 15 | 100 |
| oxide | | | |
| Fine | | | |
| particle F | | | |
| Titanium | Rutile type | 55 | 100 |
| oxide | | | |
| Fine | | | |
| particle G | | | |
| Titanium | Anataze | 15 | 100 |
| oxide | type | | |
| Fine | | | |
| particle H | | | |
| Titanium | Rutile type | 35 | 100 |
| oxide | | | |
| Fine | | | |
| particle I | | | |

| | Surface treatment | | | | | |
|---|---|---|---|---|---|---|
| | | | Amount | | | Amount |
| | | | added | | | added |
| | Treating | Molecular | (parts by | Treating | Molecular | (parts by |
| | agent A | weight | mass) | agent B | weight | mass) |
| Titanium | n-octyl | 277 | 15 | — | — | — |
| oxide | triethoxyxilane | | | | | |
| Fine | | | | | | |
| particle A | | | | | | |
| Titanium | n-octyl | 277 | 10 | Dimethyl | 120 | 6 |
| oxide | triethoxyxilane | | | Dimwthoxysilane | | |
| Fine | | | | | | |
| particle B | | | | | | |
| Titanium | n-octyl | 277 | 8 | Dimethyl | 148 | 8 |
| oxide | triethoxyxilane | | | Diethoxysilane | | |
| Fine | | | | | | |
| particle C | | | | | | |
| Titanium | n-octyl | 277 | 8 | — | — | — |
| oxide | triethoxyxilane | | | | | |
| Fine | | | | | | |
| particle D | | | | | | |
| Titanium | Dimethyl | 120 | 12 | Dimethyl | 148 | 8 |
| oxide | Dimwthoxysilane | | | Diethoxysilane | | |
| Fine | | | | | | |
| particle E | | | | | | |
| Titanium | Silicone oil | About | 20 | — | — | — |
| oxide | | 1500 | | | | |
| Fine | | | | | | |
| particle F | | | | | | |
| Titanium | n-octyl | 277 | 8 | — | — | — |
| oxide | triethoxyxilane | | | | | |
| Fine | | | | | | |
| particle G | | | | | | |
| Titanium | Silicone oil | About | 20 | — | — | — |
| oxide | | 1500 | | | | |
| Fine | | | | | | |
| particle H | | | | | | |
| Titanium | Hexamethyl | 161 | 8 | — | — | — |
| oxide | disilazane | | | | | |
| Fine | | | | | | |
| particle I | | | | | | |

### Preparation of Crystalline Polyester Resin A

Fumaric acid and 1,6-hexanediol were charged into a 5 L four-neck flask equipped with a nitrogen inlet tube, a dehydration tube, a stirrer, and a thermocouple, such that the OH/COOH molar ratio was 0.9. The mixture was reacted at 180 degrees Celsius for 10 hours in the presence of titanium tetraisopropoxide (500 ppm relative to the resin components), then heated to 200 degrees Celsius and reacted for an additional 3 hours. Subsequently, the reaction was carried out under a pressure of 8.3 kPa for 2 hours to obtain crystalline polyester resin A. The melting point of crystalline polyester resin A was 60 degrees Celsius to 80 degrees Celsius, and its weight-average molecular weight was 5,500 to 6,500.

### Preparation of Non-Crystalline Polyester Resin B

The monomers shown in Table 2 and tetra-n-butoxytitanate as a condensation catalyst were loaded in a reaction vessel equipped with a cooling tube, a stirrer, and a nitrogen introduction tube. The mixture was allowed to react at 230 degrees C. for 6 hours under a nitrogen gas flow, with the generated water being removed during the process. Next, the mixture was reacted under a reduced pressure of 5 mmHg to 20 mmHg for 1 hour to obtain amorphous polyester resin B. In Table 2, “25 percent by mol” for bisphenol A (2,2) propylene oxide indicates the proportion in the alcohol component in the case where the acid component is 50 percent by mol and the alcohol component is 50 percent by mol.

TABLE 2

| Acid component | Alcohol component | OH/COOH |
|---|---|---|
| Terephthalic acid | Bisphenol A (2,2) | 1.1 |
| | Propylene oxide (25 percent by mol) | |
| | Bisphenol A (2,2) | |
| | Ethylene oxide (25 percent by mol) | |

### Manufacturing of Mother Toner Particle

The materials below were used in manufacturing of mother toner particles.

### Binder Resin

Amorphous polyester resin B: 79 parts by mass
Crystalline polyester resin A: 8 parts by mass

### Colorant

Carbon black (#44, available from Mitsubishi Chemical Corporation): 11 parts by mass

### Release Agent

Fischer-Tropsch Wax: 5 parts by mass

### Charge Control Agent

Azo iron compound (T-77, available from HODOGAYA CHEMICAL CO., LTD.): 1 part by mass

The materials mentioned above were preliminarily mixed with a HENSCHEL MIXER (FM20B, available from NIPPON COKE & ENGINEERING CO., LTD.) and thereafter, melt-kneaded at 120 degrees Celsius with a twin-shaft kneader (PCM-30, available from Ikegai Corporation). The resulting melt-kneaded product was rolled into a thickness of 2.7 mm using a roller, then cooled to room temperature with a belt cooler and coarsely pulverized to 200 μm to 300 μm using a hammer mill. Next, the coarsely pulverized matter was finely pulverized with a supersonic pulverizer (LABO JET, available from Nippon Pneumatic Mfg. Co., Ltd.). The finely-pulverized matter was then classified with an air-stream classifier (MDS-I, available from Nippon Pneumatic Mfg. Co., Ltd.) while adjusting the aperture of the louver to obtain mother toner particles for evaluation with a weight average particle diameter of 5.8±0.2 μm.

### Example 1

To 100 parts by mass of the mother toner particles, 0.8 parts by mass of titanium oxide fine particles A and 1.3 parts by mass of hydrophobic silica (H2000T, available from Wacker Chemie AG) were added and mixed using a Henschel mixer to obtain Toner 1 of Example 1.

### Example 2

Toners 2 of Examples 2 to 5 was obtained in the same manner as in Example 1 except that titanium oxide fine particles A was changed to titanium oxide fine particles B.

### Example 3

Toner 3 of Example 3 was obtained in the same manner as in Example 1 except that titanium oxide fine particles A was changed to titanium oxide fine particles C and the amount of hydrophobic silica added was changed from 1.3 parts by mass to 2.1 parts by mass.

### Example 4

Toner 4 of Example 4 was obtained in the same manner as in Example 1 except that titanium oxide fine particles A was changed to titanium oxide fine particles D and the amount of hydrophobic silica added was changed from 1.3 parts by mass to 1.8 parts by mass.

### Comparative Example 1

Toners 5 of Comparative Example 1 was obtained in the same manner as in Example 1 except that titanium oxide fine particles A was changed to titanium oxide fine particles E.

### Comparative Example 2

Toners 6 of Comparative Example 2 was obtained in the same manner as in Example 1 except that titanium oxide fine particles A was changed to titanium oxide fine particles F.

### Comparative Example 3

Toner 7 of Comparative Example 3 was obtained in the same manner as in Example 1 except that titanium oxide fine particles A was changed to titanium oxide fine particles G and the amount of hydrophobic silica added was changed from 1.3 parts by mass to 2.2 parts by mass.

### Comparative Example 4

Toners 8 of Comparative Example 4 was obtained in the same manner as in Example 1 except that titanium oxide fine particles A was changed to titanium oxide fine particles H.

### Comparative Example 5

Toner 9 of Comparative Example 5 was obtained in the same manner as in Example 1 except that titanium oxide fine particles A was changed to titanium oxide fine particles I and the amount of hydrophobic silica added was changed from 1.3 parts by mass to 2.1 parts by mass.

The prescriptions of Toner 1 to Toner 9 are shown in Table 3.

TABLE 3

| | | External additive | | |
|---|---|---|---|---|
| | | | | Hydrophobic |
| | | Titanium oxide fine particle | | silica |
| | Mother toner | | Amount | Amount |
| | particle | | added | added |
| | (parts | | (parts | (parts |
| | by mass) | Type | by mass) | by mass) |
| Toner 1 | 100 | Titanium oxide | 0.8 | 1.3 |
| | | fine particles A | | |
| Toner 2 | 100 | Titanium oxide | 0.8 | 1.3 |
| | | fine particles B | | |
| Toner 3 | 100 | Titanium oxide | 0.8 | 2.1 |
| | | fine particles C | | |
| Toner 4 | 100 | Titanium oxide | 0.8 | 1.8 |
| | | fine particles D | | |
| Toner 5 | 100 | Titanium oxide | 0.8 | 1.3 |
| | | fine particles E | | |
| Toner 6 | 100 | Titanium oxide | 0.8 | 1.3 |
| | | fine particles F | | |
| Toner 7 | 100 | Titanium oxide | 0.8 | 2.2 |
| | | fine particles G | | |
| Toner 8 | 100 | Titanium oxide | 0.8 | 1.3 |
| | | fine particles H | | |
| Toner 9 | 100 | Titanium oxide | 0.8 | 2.1 |
| | | fine particles I | | |

Toner of 5 percent by mass and coated ferrite carrier of 95 percent by mass were uniformly mixed using a Turbula mixer (available from Willy A. Bachofen (WAB)) at 48 rpm for 5 minutes to prepare a developing agent.

The prepared developing agent was evaluated using the evaluation method described below.

### Cleaning Performance

The cleaning performance was evaluated in a test room at 10 degrees Celsius and 15 percent RH. An image forming apparatus, available from Ricoh Co., Ltd., was used to pass 5,000 sheets. Thereafter, a blank image was stopped during paper passing, and the residual transfer toner on the photoconductor, which had passed through the cleaning process, was transferred onto a blank sheet using Scotch tape (available from Sumitomo 3M Company). The transferred toner was then measured with a Macbeth reflection densitometer RD-514. A rating of B or higher was considered acceptable for practical use.

### Evaluation Criteria

A: The difference from the blank is less than 0.01
B: The difference from the blank is 0.01 to 0.02
C: The difference from the blank exceeds 0.02

### Image Quality

The image quality was evaluated totally for degradation (to be specific, transfer performance, production of background fouling image) of the image quality after paper passing. Transfer performance was evaluated by using an image forming apparatus (available from Ricoh Co., Ltd.) with a run length of 5,000 sheets. Thereafter, a solid black image was passed through the image forming apparatus to scale the transfer performance of the image visually.

In addition, the background fouling image was evaluated by using an image forming apparatus (manufactured by Ricoh Co., Ltd.) as follows: After a run length of 5,000 sheets, the image forming apparatus was suspended during printing of a white sheet image and the developing agent on the image bearer after development was transferred by a Scotch tape (Sumitomo 3M Limited). The difference between the tape and non-transferred tape was quantitatively evaluated by a spectrodensitometer (available from X-Rite). The difference less than 0.30 was rated good and, 0.30 or greater, bad. In combination of these two, both images having good quality were rated as A (Good), both images having not good but allowable quality were rated as B (Fair), and both images having not good quality were rated as C (Bad).

### Damage to Image Bearer

A total of 100,000 A4 images with 4 percent density were printed using a Ricoh image forming apparatus, and the occurrence of damage to the photoconductor was evaluated.

### Evaluation Criteria

A: No damage to the photoconductor, or only minor scratches present
B: Scratches are present on the photoconductor, but they do not cause defects in the printed image
C: Scratches are present on the photoconductor, causing defects in the printed image, or irreversible scratches are present

### Charge Stability

The developing agent was conditioned overnight in an environment of 35 degrees Celsius and 85 percent humidity. After conditioning, the charge amount was measured using a blow-off charge measuring device (TB-200 model, available from Toshiba Chemical) after stirring with a mag roller for 1 minute, obtaining the charge amount Q(1). Additionally, the charge amount was measured in the same manner after stirring with a ball mill for 60 minutes instead of a mag roller for one minute, obtaining the charge amount Q(60).

The initial charge amount was defined as Q(1), and the degraded charge amount was defined as Q(60). The charge stability under high temperature and high humidity was evaluated using the following formula. A rating of B or higher was considered acceptable for practical use.

$$\vert 1 - ( Q ( 60 ) / Q ( 1 ) ) \vert times 100 = Qst$$

### Evaluation Criteria

A: Qst is less than 20
B: Qst is 20 to less than 40
C: Qst is 40 or more

### Developing Process Durability

After continuous printing, full solid images and blank images were visually inspected for abnormalities such as the occurrence of white streaks, black streaks, or image fading. The evaluation was conducted based on the following criteria: A rating of A or higher was considered acceptable for practical use.

### Evaluation Criteria

S: No abnormal images occur
A: Defective images occur at a level that is not bothersome to a user
B: Signs of issues are present, but they do not appear at a problematic level in the printed output
C: Apparently defective images occur

The evaluation results of the toners of Examples and Comparative Examples are shown in Table 4.

TABLE 4

| | | Evaluation | | | | |
|---|---|---|---|---|---|---|
| | | | | | | Developing |
| | | Cleaning | Image | Damage to | Charge | process |
| | Toner | performance | quality | photoconductor | stability | durability |
| Example 1 | Toner | A | A | A | A | S |
| | 1 | | | | | |
| Example 2 | Toner | A | A | A | A | S |
| | 2 | | | | | |
| Example 3 | Toner | B | A | B | A | S |
| | 3 | | | | | |
| Example 4 | Toner | A | A | A | A | A |
| | 4 | | | | | |
| Comparative | Toner | A | A | A | B | C |
| Example 1 | 5 | | | | | |
| Comparative | Toner | C | A | A | B | B |
| Example 2 | 6 | | | | | |
| Comparative | Toner | B | A | C | A | A |
| Example 3 | 7 | | | | | |
| Comparative | Toner | A | C | A | B | A |
| Example 4 | 8 | | | | | |
| Comparative | Toner | B | A | B | C | B |
| Example 5 | 9 | | | | | |

As seen in the evaluation results of Examples 1 to 4, it was found that using titanium oxide fine particles, which are obtained by hydrophobizing rutile titanium oxide with a particle diameter of 10 nm to 35 nm with a silane coupling agent containing n-octyltriethoxysilane, as an external additive enables the production of a toner with excellent flowability and charge stability while image quality degradation is controlled.

Aspects of the embodiments of the present invention are, for example, as follows:

### Aspect 1

A toner contains a binder resin, a colorant, and an external additive that contains a titanium oxide fine particle hydrophobized with a silane coupling agent containing n-octyltriethoxy silane, wherein the titanium oxide fine particle contains rutile titanium oxide having a particle diameter of 10 to 35 nm.

### Aspect 2

The toner according to Aspect 1 mentioned above, wherein the silane coupling agent further contains a short-chain silane coupling agent having a molecular weight of at most 160.

### Aspect 3

The toner according to Aspect 2 mentioned above, wherein the short-chain silane coupling agent contains one of dimethyldimethoxysilane, methyltrimethoxysilane, and dimethyldiethoxysilane.

### Aspect 4

The toner according to any one of aspects 1 to 3 mentioned above, wherein the external additive further contains a hydrophobic silica.

### Aspect 5

The toner according to any one of aspects 1 to 4 mentioned above, wherein the binder resin contains a crystalline resin.

### Aspect 6

A developing agent contains the toner of any one of aspects 1 to 5 mentioned above.

### Aspect 7

A developing agent container contains the developing agent of Aspect 6 mentioned above.

### Aspect 8

An image forming method includes forming a latent electrostatic image on a latent electrostatic image bearer, developing the latent electrostatic image with the developing agent of Aspect 6 mentioned above to form a visible image, transferring the visible image to the surface of a transfer medium, and fixing the visible image transferred onto the surface of the transfer medium.

### Aspect 9

An image forming apparatus includes a latent electrostatic image bearer, a latent electrostatic image forming device to form a latent electrostatic image on the latent electrostatic image bearer, a developing device to develop the latent electrostatic image with the developing agent of Aspect 6 mentioned above to form a visible image, a transfer device to transfer the visible image onto the surface of a transfer medium, and a fixing device to fix the visible image transferred onto the surface of the transfer medium.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A toner comprising:
a binder resin;
a colorant; and
an external additive comprising:
a titanium oxide fine particle hydrophobized with a silane coupling agent containing n-octyltriethoxy silane,
wherein the titanium oxide fine particle comprises rutile titanium oxide having a particle diameter of 10 to 35 nm.

2. The toner according to claim 1,
wherein the silane coupling agent further contains a short-chain silane coupling agent having a molecular weight of at most 160.

3. The toner according to claim 2,
wherein the short-chain silane coupling agent comprises one of dimethyldimethoxysilane, methyltrimethoxysilane, and dimethyldiethoxysilane.

4. The toner according to claim 1,
wherein the external additive further comprises a hydrophobic silica.

5. The toner according to claim 1,
wherein the binder resin comprises a crystalline resin.

6. A developing agent comprising:
the toner of claim 1.

7. A developing agent container accommodating the developing agent of claim 6.

8. An image forming method comprising:
forming a latent electrostatic image on a latent electrostatic image bearer;
developing the latent electrostatic image with the developing agent of claim 6 to form a visible image;
transferring the visible image to a surface of a transfer medium; and
fixing the visible image transferred onto the surface of the transfer medium.

9. An image forming apparatus comprising:
a latent electrostatic image bearer;
a latent electrostatic image forming device to form a latent electrostatic image on the latent electrostatic image bearer;
a developing device to develop the latent electrostatic image with the developing agent of claim 6 to form a visible image;
a transfer device to transfer the visible image onto a surface of a transfer medium; and
a fixing device to fix the visible image transferred onto the surface of the transfer medium.
